(19) United States
(12) Patent Application Publication
(10) Pub. No.: US 2013/0107372 A1
(43) Pub. Date: May 2, 2013

(54) DISPLAYING DEVICE FOR PROJECTING IMAGE ONTO PUPILS

(71) Applicants: Wen-Hsin Sun, Taoyuan County (TW); Bo-Jun Chen, Taoyuan County (TW); Ching-Cherng Sun, Yangmei City (TW)

(72) Inventors: Wen-Hsin Sun, Taoyuan County (TW); Bo-Jun Chen, Taoyuan County (TW); Ching-Cherng Sun, Yangmei City (TW)

(73) Assignee: National Central University, Taoyuan County (TW)

(21) Appl. No.: 13/286,411

(22) Filed: Nov. 1, 2011

(51) Int. Cl. G02B 27/01

(52) U.S. Cl. 359/630

(57) ABSTRACT

A displaying device for projecting image onto pupils includes a light source emitting a light beam, a first light splitter reflecting the light beam, an image unit providing an image message, a displayer integrating the light beam form the first light splitter and the image message from the image unit into an image beam, a first lens focusing the image beam and a second light splitter transforming the image beam into a enlarged virtual image and projecting the enlarged virtual image onto user's pupils for a user to watch. The second light splitter is placed in front of user's pupils and is transparent to transmit the view around the user to user's pupils.

### BACKGROUND OF THE INVENTION

1. Field of the Invention

The present invention relates to a displaying device, and more particularly to a displaying device for projecting image onto pupils.

2. Description of Related Art

Nowadays, LED monitors are widely used to the portable devices, such as smart phones, tablet computers, handheld video game devices . . . etc. Thus, people can enjoy different kinds of entertainments from these portable devices in the leisure time. However, to watch the video or movie on these portable devices for several hours often causes people to feel uncomfortable, especially on their necks and hands.

In order to improve the shortcoming mentioned above, a manufacturer designs a conventional display device which is worn on a user's head. An image system and a refractive lens set are commonly used in the conventional display device. A mapping image from the image system passes through the refractive lens set to be enlarged as a virtual image which is mapping onto the user's pupils. Thus, the user can comfortably enjoy the video or movie via the conventional display device.

Unfortunately, the conventional display device still has one shortcoming. When the mapping image passes through the refractive lens set, the virtual image becomes ambiguous because of the energy loss of photons.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved displaying device.

To achieve the objective, a displaying device for projecting image onto pupils comprises a light source emitting light beams, a first light splitter reflecting the light beams, an image unit providing an image message, a displayer integrating the light beams form the first light splitter and the image message from the image unit into an image beam, a first lens focusing the image beam, a second light splitter transforming the image beam into an enlarged virtual image and projecting the enlarged virtual image onto user's pupils for a user to watch.

Wherein, the light source is LEDs with different colors mixing with a white-light LED; a second lens is mounted between the light source and the first light splitter; the second lens refracts the light beams from the light source to form a series of parallel light beams to the first light splitter.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a displaying device for projecting image onto pupils for showing an arrangement;

FIG. 2 is another perspective view of the displaying device for projecting image onto pupils for showing a light beam and an image beam;

FIG. 3 is a perspective view of the displaying device for projecting image onto pupils applied in glasses; and

FIG. 4 is a perspective view for showing a user to wear an eye wear with the displaying device for projecting image onto pupils.

### DETAILED DESCRIPTION OF THE INVENTION

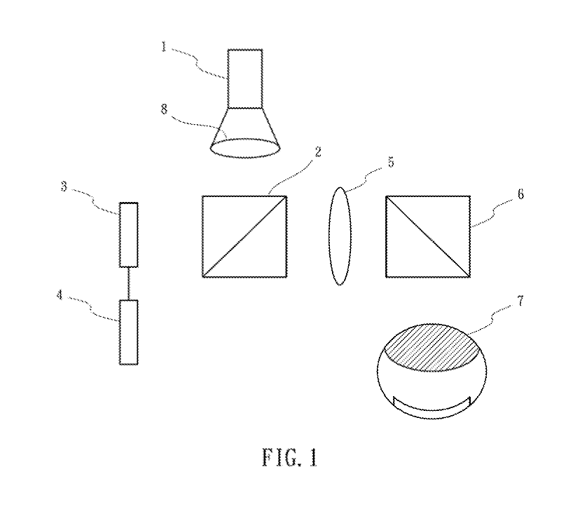

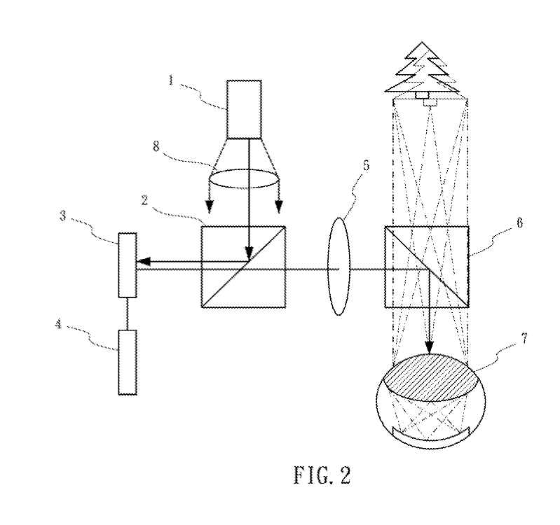

Referring to FIGS. 1-2, a displaying device for projecting image onto pupils in accordance with the present invention comprises a light source 1, a first light splitter 2, a displayer 3, an image unit 4, a first lens 5 and a second light splitter 6. The light source 1 is LEDs (Red, Green, Blue) mixing with a white-light LED. The light source 1 emits light beams to the first light splitter 2. The first light splitter 2 splits up the light beams into an S-polarized light beam (as shown in FIG. 2) and a P-polarized light beam (not shown). The S-polarized light beam form the first light splitter 2 is perpendicular to the light beams from the light source 1. The S-polarized light beam is reflected to the displayer 3 by the first light splitter 2. The image unit 4 provides an image message to the displayer 3. The displayer 3 integrates the S-polarized light beam form the first light splitter 2 and the image message from the image unit 4 into an image beam. The image beam from the displayer 3 is parallel to the S-polar light beam form the first light splitter 2. The image beam is transmitted to the first light splitter 2 by the displayer 3. The first light splitter 2 splits up the image beam into an S-polarized image beam (not shown) and a P-polarized image beam (as shown in FIG. 2). The P-polar image beam is transmitted to the first lens 5 via the first light splitter 2. The first lens 5 focuses the P-polar image beam and then transmits the P-polar image beam to the second light splitter 6. The second light splitter 6 transforms the P-polar image beam into an enlarged virtual image and projects the enlarged virtual image onto user's pupils 7 for a user to watch. Furthermore, a second lens 8 is mounted between the light source 1 and the first light splitter 2. The second lens 8 refracts the light beams from the light source 1 to form a series of parallel light beams to the first light splitter 2, so that the interference from the air is decreasing.

Under this arrangement, the light source 1, the first light splitter 2, the displayer 3, the image unit 4 and the first lens 5 are placed close to user's head. The second light splitter 6 is placed in front of user's pupils 7 and the second light splitter 6 is transparent to transmit the view around the user to user's pupils 7. Therefore, the displaying device for projecting image onto pupils not only provides the digital image from the image unit 4 which the user wants to know, but also provides the view of the situation around the user itself.

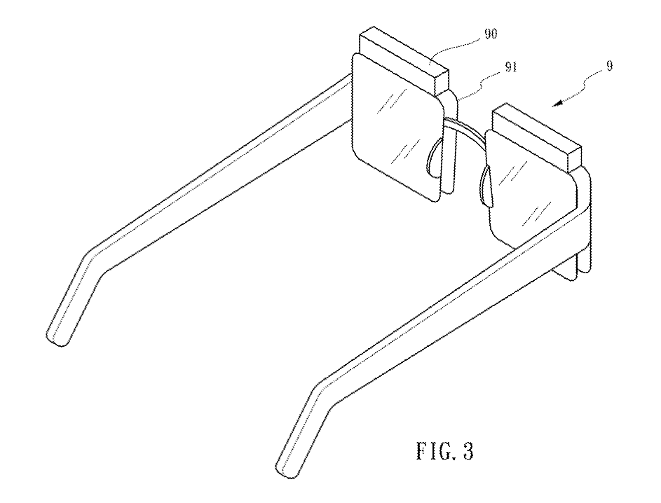

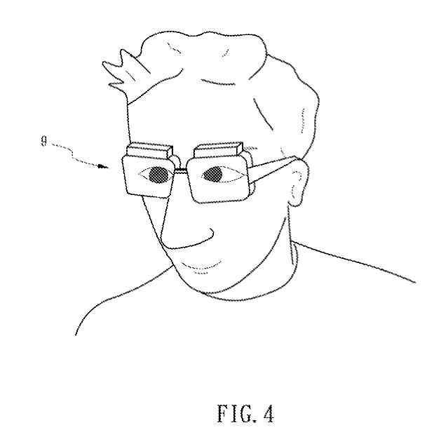

Referring to FIG. 3, the displaying device for projecting image onto pupils is further mounted to an eye wear 9. The light source 1, the first light splitter 2, the displayer 3, the image unit 4 and the first lens 5 are set up in a cover 90 of the eye wear 9. A plurality of second light splitters 91 is mounted to the eye wear 9. Referring to FIG. 4, when the user wears the eye wear 9, the displaying device for projecting image onto pupils not only provides the digital image from the image unit 4 which the user wants to know, but also provides the view of the situation around the user itself.

Although the invention has been explained in relation to its preferred embodiment, it is to be understood that many other possible modifications and variations can be made without departing from the spirit and scope of the invention as hereinafter claimed.

What is claimed is:

1. A displaying device for projecting image onto pupils comprising:
a light source emitting light beams;
a first light splitter reflecting the light beams;
an image unit providing an image message;
a displayer integrating the light beams form the first light splitter and the image message from the image unit into an image beam;
a first lens focusing the image beam; and
a second light splitter transforming the image beam into an enlarged virtual image and projecting the enlarged virtual image onto user's pupils for a user to watch.

2. The displaying device for projecting image onto pupils as claimed in claim 1, wherein the light source is LEDs with different colors mixing with a white-light LED.

3. The displaying device for projecting image onto pupils as claimed in claim 1, wherein a second lens is mounted between the light source and the first light splitter; the second lens refracts the light beams from the light source to form a series of parallel light beams to the first light splitter.
